(19) United States
(12) Patent Application Publication
(10) Pub. No.: US 2017/0129220 A1
(43) Pub. Date: May 11, 2017

(54) FILM FOR LAMINATED GLASS, AND LAMINATED GLASS

(71) Applicant: Konica Minolta, Inc., Tokyo (JP)

(72) Inventor: Yukako TAKA, Inagi-shi, Tokyo (JP)

(73) Assignee: Konica Minolta, Inc., Tokyo (JP)

(21) Appl. No.: 15/314,748

(22) PCT Filed: May 27, 2015
(86) PCT No.: PCT/JP2015/065187

§ 371 Date: Nov. 29, 2016

(30) Foreign Application Priority Data
May 30, 2014 (JP) 2014-112433

(51) Int. Cl. B32B 17/10; B32B 3/28

(52) U.S. Cl. CPC B32B 17/10779; B32B 3/28; B32B 2255/10; B32B 2255/20; B32B 2307/416; B32B 2307/736; B32B 2605/08

(57) ABSTRACT

Provided is a film for laminated glass, the film exhibiting satisfactory in-plane uniformity when processed into a laminated glass, and excellent processing suitability for a glass having a curved surface. Provided is also a laminated glass provided with the film for laminated glass.

The film for laminated glass of the present invention is a film for laminated glass, which has a resin film; and an optically functional layer containing a polymer on at least one surface of the resin film, and in which the heat shrinkage rate (S₁) of the film for laminated glass and the heat shrinkage rate (S₂) of the resin film obtainable after the films are left to stand for 30 minutes in an environment at 130° C. are respectively adjusted so as to satisfy the following expression (I) in a direction in the plane as well as a direction orthogonal thereto:

0.60≦S₁/S₂≦0.98 Expression (I):

### TECHNICAL FIELD

The present invention relates to a film for laminated glass, and a laminated glass. More particularly, the invention relates to a film for laminated glass, which has satisfactory in-plane uniformity when processed into a laminated glass and has excellent processing suitability for a glass having a curved surface. The invention also relates to a laminated glass provided with the film for laminated glass.

### BACKGROUND ART

In recent years, for the purpose of blocking the heat felt due to the sunlight penetrating through windowpanes, suppressing the operation of car air-conditioners, and saving energy, laminated glasses having high heat insulation properties or heat ray shielding properties have been distributed in the market.

Generally, a laminated glass has a film for laminated glass disposed between a pair of glass substrates, and the relevant film for laminated glass plays the role of blocking the penetration of the heat rays (infrared radiation) of sunlight, and thereby reducing the indoor temperature rise or the cooling load.

Patent Literature 1 discloses that an infrared reflective film obtained by laminating dielectric substances having different refractive indices, is formed into a plastic film. Patent Literature 2 discloses a laminated glass having inserted therein a plastic film, to which an infrared reflective film having a heat shrinkage rate in the range of 0.1% to 3% is attached. Furthermore, Patent Literature 3 discloses a laminated glass having a curved surface, in which a film having a heat shrinkage rate of 0.8% or less, and an intermediate film are laminated. Furthermore, Patent Literature 4 describes that in regard to a polyester film for an intermediate film for laminated glass, if the value of heat shrinkage rate of the film obtainable after a heat treatment is too large, the polyester film has undulate defects occurring in the external appearance.

However, it was found that even if the technologies described in the patent literatures mentioned above are applied, the in-plane uniformity of the optical characteristics is insufficient, and particularly when the materials are processed into laminated glasses having curved surfaces, there is a problem with the generation of undulation, wrinkles and the like.

### CITATION LIST

### Patent Literature

Patent Literature 1: JP 2007-148330 A

Patent Literature 2: JP 2010-265161 A

Patent Literature 3: JP 2013-209246 A

Patent Literature 4: JP 2009-208980 A

### SUMMARY OF INVENTION

### Technical Problem

The present invention has been made in view of the problems and the circumstances, and an object of the present invention is to provide a film for laminated glass, which has satisfactory in-plane uniformity when processed into laminated glass, and has excellent processing suitability for a glass having a curved surface. Another object is to provide a laminated glass provided with the film for laminated glass.

### Solution to Problem

In order to solve the problems described above, the inventors of the present invention conducted an investigation on the cause and the like of the problems. As a result, the inventors found that when the value of the ratio of heat shrinkage rates of a resin film and a film for laminated glass is adjusted within a particular range, the non-uniformity of shrinkage in the film, which is considered to be causative of phenomena that impair the external appearance, such as undulation and wrinkles, is suppressed, and the in-plane uniformity is increased. Thus, the inventors completed the present invention.

That is, the above-described problems of the present invention are solved by the following means.

1. A film for laminated glass, the film including a resin film; and an optically functional layer containing a polymer on at least one surface of the resin film, wherein the heat shrinkage rate (S₁) of the film for laminated glass and the heat shrinkage rate (S₂) of the resin film obtainable after the films are left to stand for 30 minutes in an environment at 130° C. are respectively adjusted so as to satisfy the following expression (I) in a direction in the plane as well as a direction orthogonal thereto:

0.60≦S₁/S₂≦0.98 Expression (I):

2. The film for laminated glass of Item. 1, wherein a laminated glass provided with the film for laminated glass is a laminated glass having a curved surface.

3. The film for laminated glass of Item. 1 or 2, wherein the thickness of the optically functional layer and the thickness of the resin film satisfy the following expression (II):

0.035≦thickness of optically functional layer/thickness of resin film≦7.0 Expression (II):

4. The film for laminated glass of any one of Items. 1 to 3, wherein the heat shrinkage rate (S₂) of the resin film obtainable after the resin film is left to stand for 30 minutes in an environment at 130° C. is more than 3.0% in a direction in the plane as well as a direction orthogonal thereto.

5. The film for laminated glass of any one of Items. 1 to 4, wherein the optically functional layer has a layer formed by alternately laminating a high refractive index layer containing at least fine metal oxide particles and a water-soluble polymer, and a low refractive index layer containing at least a water-soluble polymer.

6. The film for laminated glass of anyone of Items. 1 to 5, wherein the optically functional layer is an infrared reflective layer.

7. A laminated glass including the film for laminated glass of any one of Items. 1 to 6.

### Advantageous Effects of Invention

A film for laminated glass which has satisfactory in-plane uniformity when processed into a laminated glass and has excellent processing suitability for a glass having a curved surface, can be provided with the above-described means of the present invention. Furthermore, a laminated glass provided with the film for laminated glass can be provided.

The mechanism for manifesting the effects of the present invention or the operating mechanism of the present invention is not clearly understood; however, the mechanisms are speculated to be as follows.

In a case in which the heat shrinkage rate of a film for laminated glass obtained by laminating a resin film and an optically functional layer is lower than the heat shrinkage rate of a resin film, when the film for laminated glass is processed into a laminated glass by means of heat, the film for laminated glass does not easily shrink compared to the resin film. Therefore, the non-uniformity of shrinkage in the film plane is reduced, and even if the resin film shrinks, large undulation of the resin film becomes imperceptible when the film for laminated glass is processed into a laminated glass, while undulation also does not occur in the optically functional layer itself. Therefore, it is speculated that in-plane uniformity is enhanced.

### BRIEF DESCRIPTION OF DRAWINGS

FIG. 1A is a schematic cross-sectional diagram illustrating an example of a laminated glass of the present invention.

FIG. 1B is a schematic cross-sectional diagram illustrating another example of the laminated glass of the present invention.

### DESCRIPTION OF EMBODIMENTS

A film for laminated glass of the present invention is a film for laminated glass, which has a resin film and an optically functional layer containing a polymer on at least one surface of the resin film, and in which the heat shrinkage rate (S₁) of the film for laminated glass and the heat shrinkage rate (S₂) of the resin film obtainable after the films have been left to stand for 30 minutes in an environment at 130° C. are respectively adjusted so as to satisfy the expression (I) described above in a direction in the plane as well as a direction orthogonal thereto. This feature is a technical feature that is common to the inventions according to claim 1 to claim 7.

According to an embodiment of the present invention, from the viewpoint of manifesting the effects of the present invention, it is preferable that the laminated glass provided with a film for laminated glass is a laminated glass having a curved surface. Furthermore, it is preferable that the thickness of the optically functional layer and the thickness of the resin film satisfy the expression (II) described above, because the in-plane uniformity can be enhanced.

Furthermore, according to the present invention, it is preferable that the heat shrinkage rate (S₂) of the resin film obtainable after the film is left for 30 minutes in an environment at 130° C., is more than 3.0% in a direction in the plane as well as a direction orthogonal thereto. Thereby, the processing suitability for a glass having a curved surface is enhanced.

Furthermore, from the viewpoint of increasing the infrared reflectance, it is preferable that the optically functional layer has a layer formed by alternately laminating a high refractive index layer containing at least fine metal oxide particles and a water-soluble polymer, and a low refractive index layer containing at least a water-soluble polymer.

The film for laminated glass of the present invention can be suitably included in a laminated glass.

Hereinafter, the present invention and constituent elements thereof, and embodiments for carrying out the present invention will be explained in detail. According to the present invention, “to” between numerical values is used to mean to include the numerical values described before and after “to” as the lower limit and the upper limit.

<<Film for Laminated Glass>>

The film for laminated glass of the present invention is a film for laminated glass having a resin film and an optically functional layer containing a polymer on at least one surface of the resin film, in which the heat shrinkage rate (S₁) of the film for laminated glass and the heat shrinkage rate (S₂) of the resin film obtainable after the films have been left to stand for 30 minutes in an environment at 130° C., are respectively adjusted to satisfy the following expression (I) in a direction in the plane as well as a direction orthogonal thereto:

0.60≦S₁/S₂≦0.98 Expression (I):

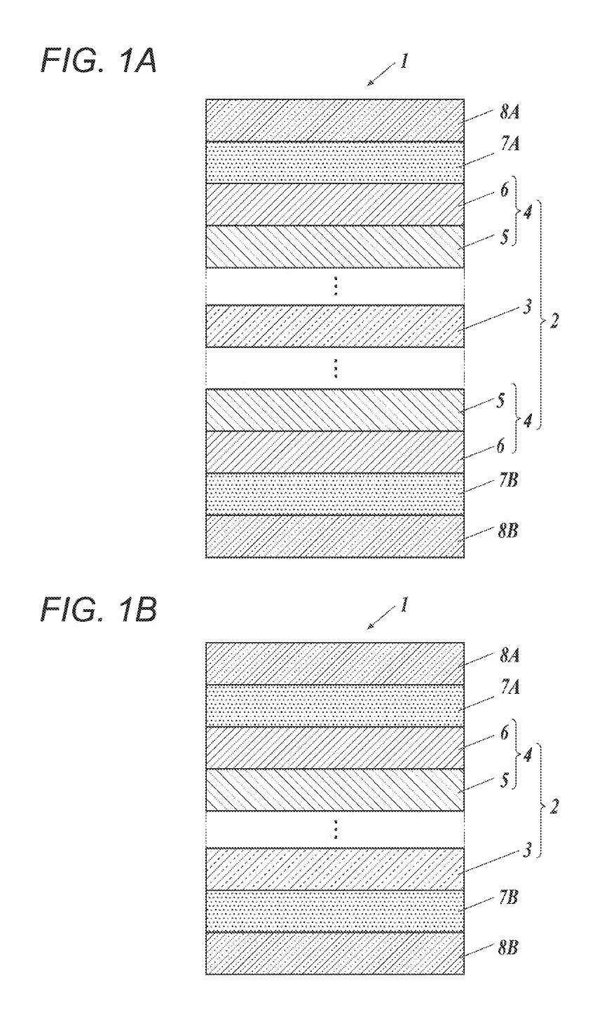

First, the basic configurations of the film for laminated glass and the laminated glass of the present invention in a case in which the optically functional layer is an infrared reflective layer will be explained with reference to FIG. 1.

FIG. 1 is a schematic cross-sectional diagram illustrating an example of the laminated glass of the present invention.

In FIG. 1A, a laminated glass 1 is configured to include a film for laminated glass 2 and a pair of glass substrates 8A and 8B that sandwich the film for laminated glass 2. Furthermore, the film for laminated glass 2 has an infrared reflective layer 4 formed by alternately laminating a high refractive index layer 5 and a low refractive index layer 6, on a resin film 3. Furthermore, adhesive layers 7A and 7B are provided on both surfaces of the film for laminated glass 2, and the film for laminated glass 2 is adhered to the pair of glass substrates 8A and 8B by these adhesive layers.

FIG. 1B is an example of the case in which the infrared reflective layer 4 is provided on only one surface of the resin film 3.

The film for laminated glass of the present invention has a resin film and an optically functional layer containing a polymer, and the film for laminated glass is acceptable as long as it satisfies expression (I), and can include other constituent layers as necessary.

The overall thickness of the film for laminated glass is preferably in the range of 30 to 200 μm, more preferably in the range of 40 to 150 μm, and even more preferably 40 to 125 μm.

Regarding the optical characteristics of the film for laminated glass, the visible light transmittance measured according to JIS R 3106 (1998) is preferably 60% or higher, more preferably 70% or higher, and even more preferably 80% or higher. Furthermore, it is preferable that the film for laminated glass has a region having a reflectance of more than 50% in a wavelength range of 800 to 1400 nm.

The laminated glass is produced by bonding a film for laminated glass having an optically functional layer on a resin film, to a pair of glass substrates by heating the assembly at a high temperature for 10 to 60 minutes.

Bonding is usually carried out at 100° C. to 150° C.; however, at that time, the respective heat shrinkage rates of various constituent layers of the resin film used in the laminated glass and the layers that constitute the optically functional layer, and the differences in the heat shrinkage rates may cause generation of undulation and wrinkles and impairment of the external appearance. Particularly, in a case in which the difference in the heat shrinkage rates between adjacent layers is large, since another layer cannot conform to a layer having a large heat shrinkage rate, non-uniformity of shrinkage occurs within the film due to the difference of heat shrinkage rates during the process for producing a laminated glass. For this reason, it is considered that the film for laminated glass warps, and causes the generation of wrinkles.

The inventors of the present invention conducted an investigation on the causes of the above-described problems and the like in order to address the objects, and as a result, the inventors found that when the value of the ratio of heat shrinkage rates of the resin film and the film for laminated glass is adjusted to be within a particular range, the non-uniformity of shrinkage within the film, which is considered to be causative of phenomena that impair the external appearance, such as undulation and wrinkles, is suppressed, and the in-plane uniformity is enhanced. Thus, the inventors completed the present invention.

It is speculated that, probably, since it is more difficult for the film for laminated glass to shrink than the resin film, even if the resin film shrinks, when the resin film is processed into a laminated glass, the large undulation of the resin film becomes invisible, and undulation also does not occur in the optically functional layer itself, the in-plane uniformity therefore being enhanced.

It is necessary for the film for laminated glass of the present invention that the heat shrinkage rate (S₁) of the film for laminated glass and the heat shrinkage rate (S₂) of the resin film obtainable after the films have been left to stand for 30 minutes in an environment at 130° C., are respectively adjusted such that the ratio (S₁/S₂) as shown in the expression (I) is in the range of 0.60 to 0.98 in a direction in the plane as well as a direction orthogonal thereto, and it is more preferable that the ratio is adjusted to be within the range of 0.70 to 0.93%. In a case in which the ratio (S₁/S₂) represented by the expression (I) is below 0.60, wrinkles and undulation are likely to appear, which is not preferable. Furthermore, in a case in which the ratio is above 0.98, it is not preferable from the viewpoint of in-plane uniformity.

Furthermore, it was found that when the heat shrinkage rate (S₂) of the resin film obtainable after the resin film has been left to stand for 30 minutes in an environment at 130° C. is more than 3.0% in a direction in the plane as well as a direction orthogonal thereto, the resin film can be easily bonded even to a curved glass. The heat shrinkage rate is preferably in the range of 3.1% to 6.0%. It is because when the heat shrinkage rate is 6.0% or less, handling at the time of processing is made easier.

When these heat shrinkage rates adopt similar behavior in the longitudinal direction and a direction orthogonal thereto, particularly even in a laminated glass having a curved surface, a laminated glass having satisfactory external appearance that is free of undulation or wrinkles is easily obtained.

In order to obtain a film for laminated glass having such characteristics, the obtainment can be achieved by controlling the kind of the resin film that will be described below, additives in the resin, and the film-forming conditions, particularly the stretching conditions; and by controlling the kind and amount of addition of the polymer to be included in the optically functional layer, and the film-forming conditions, particularly the stretching conditions; and the like.

<Measurement of Heat Shrinkage Rate>

According to the present invention, measurement of the heat shrinkage rate is conducted as follows.

A film for laminated glass is stored for 24 hours in an environment at a temperature of 23° C. and a relative humidity of 55%, and then two marks are made at an interval of 100 mm in the width direction. The distance L₁ between the two marks is measured in an unloaded state using a microscope or the like. Subsequently, the sample is suspended in an oven in an environment at 130° C., and is left to stand for 30 minutes. After a lapse of 30 minutes, the sample is taken out from the oven, and the sample is stored again for 24 hours in an environment at a temperature of 23° C. and a relative humidity of 55%. Subsequently, the distance L₂ between the two marks on the sample is measured in an unloaded state using a microscope or the like. From the distances L₁ and L₂ thus measured, the heat shrinkage rate of the sample is calculated by the following expression:

Heat shrinkage rate (%)=((L₁−L₂)/L₁)×100

The heat shrinkage rate of the resin film is also calculated in the same manner.

According to the present invention, unless particularly stated otherwise, measurement of the heat shrinkage rates of a sample is conducted respectively under the same conditions. Furthermore, the one direction in the film plane and a direction orthogonal thereto are preferably the conveyance direction (MD direction) of the support and a direction orthogonal thereto (TD direction), respectively.

<<Resin Film>>

The resin film used for the glass for laminated film according to the present invention accomplishes the role as a support for the film for laminated glass. In regard to the resin film according to the present invention, the material, thickness and the like should be set such that the heat shrinkage rate (S₁) of the film for laminated glass and the heat shrinkage rate (S₂) of the resin film satisfy the expression (I) in a direction in the plane as well as a direction orthogonal thereto.

Meanwhile, in the case of a film for laminated glass in which an optically functional layer is interposed between two sheets of resin films, it is desirable that a thicker one of the resin films takes the role as a support, and this resin film is set so as to satisfy the expression (I) described above.

The thickness of the resin film according to the present invention is preferably in the range of 30 to 200 μm, more preferably in the range of 30 to 150 μm, and most preferably in the range of 35 to 125 μm. When the thickness is 30 μm or more, wrinkles are not likely to occur during handling, and when the thickness is 200 μm or less, on the occasion when the resin film is bonded to glass, shape conformity to a glass curved surface is improved, and wrinkles are not likely to occur.

The resin film according to the present invention is preferably a biaxially oriented polyester film; however, as long as the film thus obtained maintains the gist of the present invention, an unstretched polyester film or a polyester film that has been stretched in at least one direction can also be used. From the viewpoints of enhancing strength and suppressing thermal expansion, a stretched film is preferred. Particularly when the laminated glass is used as a windshield for automotive use, a stretched film is more preferred.

As the resin film that is applicable to the film for laminated glass of the present invention, it is preferable that the resin film is transparent. Regarding the optical characteristics of the film for laminated glass, the visible light transmittance measured according to JIS R 3106 (1998) is preferably 70% or higher, more preferably 80% or higher, and even more preferably 90% or higher.

Regarding the resin film having such characteristics, various resin films can be used. For example, a polyolefin film (for example, polyethylene or polypropylene); a polyester film (for example, polyethylene terephthalate or polyethylene naphthalate); a film of polyvinyl chloride, cellulose triacetate, polyimide or polybutyral; a cycloolefin polymer film; or a transparent cellulose nanofiber film can be used. A polyester film is preferred.

The polyester film (hereinafter, also referred to as polyester) is not particularly limited; however, the polyester film is preferably a polyester containing a dicarboxylic acid component and a diol compound as main constituent components and having film-forming properties. Examples of the dicarboxylic acid component as a main constituent component include terephthalic acid, isophthalic acid, phthalic acid, 2,6-naphthalenedicarboxylic acid, 2,7-naphthalenedicarboxylic acid, diphenylsulfone dicarboxylic acid, diphenyl ether dicarboxylic acid, diphenylethane dicarboxylic acid, cyclohexanedicarboxylic acid, diphenyldicarboxylic acid, diphenyl thioether dicarboxylic acid, diphenyl ketone dicarboxylic acid, and phenylindane dicarboxylic acid. Furthermore, examples of the diol component include ethylene glycol, propylene glycol, tetramethylene glycol, cyclohexanedimethanol, 2,2-bis(4-hydroxyphenyl)propane, 2,2-bis(4-hydroxyethoxyphenyl)propane, bis(4-hydroxyphenyl)sulfone, bisphenol fluorene dihydroxyethyl ether, diethylene glycol, neopentyl glycol, hydroquinone, and cyclohexanediol. Among the polyesters containing these compounds as main constituent components, from the viewpoints of transparency, mechanical strength, dimensional stability and the like, a polyester containing terephthalic acid or 2,6-naphthalenedicarboxylic acid as a dicarboxylic acid component, and ethylene glycol or 1,4-cyclohexanedimethanol as main constituent components is preferred. Above all, a polyester containing polyethylene terephthalate or polyethylene naphthalate as a main constituent component; a copolymerized polyester formed from terephthalic acid, 2,6-naphthalenedicarboxylic acid and ethylene glycol; and a polyester containing a mixture of two or more kinds of these polyesters, are preferred.

The resin film according to the present invention may contain particles in order to facilitate handling, on condition that the particles do not impair transparency. Examples of the particles that may be used for the present invention include inorganic particles of calcium carbonate, calcium phosphate, silica, kaolin, talc, titanium dioxide, alumina, barium sulfate, calcium fluoride, lithium fluoride, zeolite, and molybdenum sulfide; crosslinked polymer particles; and organic particles of calcium oxalate and the like. Furthermore, regarding the method for adding particles, a method of adding particles by incorporating the particles into the resin material used as a raw material; a method of directly adding the particles to an extruder; and the like may be mentioned, and any one of these methods may be employed, or two methods may be used in combination. According to the present invention, additives may also be added as necessary, in addition to the particles. Examples of such additives include a stabilizer, a lubricating agent, a crosslinking agent, an antiblocking agent, an oxidation inhibitor, a dye, a pigment, and an ultraviolet absorber.

The resin film can be produced by a conventionally known general method. For example, an unstretched resin film that is substantially amorphous and unoriented can be produced by melting a resin that serves as a material using an extruder, extruding the molten resin through an annular die or a T-die, and then rapidly cooling the extruded resin. Furthermore, a stretched resin film can be produced by stretching an unstretched resin film in the flow direction (MD) or a direction perpendicular to the flow direction of the resin film (TD) by means of a known method such as uniaxial stretching, tenter type sequential biaxial stretching, tenter type simultaneous biaxial stretching, or tubular type simultaneous biaxial stretching. The stretch ratio used in this case can be appropriately stretched in accordance with the resin that serves as a raw material of the resin film; however, the stretch ratio is preferably 2 to 10 times respectively in the MD direction and the TD direction.

The resin film may also be subjected to a relaxation treatment and an offline heat treatment, in view of dimensional stability. “Relaxation” refers to an operation of conveying a resin film while gripping both edges of the film with clamps, slackening the film in at least one direction selected from the longitudinal direction and the transverse direction, and thereby relaxing the stress. It is preferable that a relaxation treatment is carried out by a step of thermally fixing the polyester film during a stretching film-forming step, and then winding the polyester film inside a lateral stretching tenter or after having passed through a tenter. It is preferable that the relaxation treatment is carried out at a treatment temperature of 80° C. to 200° C., and more preferably at a treatment temperature of 100° C. to 180° C. Furthermore, it is preferable that the relaxation treatment is carried out at a relaxation ratio in the range of 0.1% to 10% in both the longitudinal direction and the width direction, and more preferably, the relaxation treatment is carried out at a relaxation ratio of 2% to 6%. When the relaxation-treated resin film is subjected to an offline heat treatment such as described below, heat resistance is enhanced, and satisfactory dimensional stability is obtained.

It is preferable that an undercoating layer coating liquid is applied in-line on the resin film on one surface or both surfaces during the film-forming operation. According to the present invention, the application of undercoating during the film-forming operation is referred to as in-line undercoating. Examples of the resin that is used for an undercoating layer coating liquid useful for the present invention include a polyester resin, an acrylic-modified polyester resin, a polyurethane resin, an acrylic resin, a vinyl resin, a vinylidene chloride resin, a polyethyleneimine vinylidene resin, a polyethyleneimine resin, a polyvinyl alcohol resin, a modified polyvinyl alcohol resin, and gelatin. All of these can be preferably used. Into undercoating layers of these resins, conventionally known additives can also be incorporated. The undercoating layer can be applied by a known method such as roll coating, gravure coating, knife coating, dip coating, or spray coating. The coating amount of the undercoating layer is preferably about 0.01 to 2 g/m² (dried state).

<<Optically Functional Layer>>

The optically functional layer according to the present invention is a layer having a function of controlling optical characteristics, and although there are no particular limitations, the optically functional layer can be preferably used as an optically reflective layer that selectively transmits or blocks light having a particular wavelength. Particularly, the optically functional layer can be preferably applied as an infrared reflective film that transmits or blocks light having a wavelength ranging from the visible light region to the infrared region.

Regarding a layer that selectively transmits or blocks light having a particular wavelength, a layer that is produced by alternately laminating low refractive index layers and high refractive index layers and thus reflects only a light having a wavelength corresponding to the layer thickness (reflective layer based on a multilayer film), or a layer that absorbs light having a particular wavelength by means of a dye or a pigment, may be mentioned.

<Reflective Layer Based on Multilayer Film>

According to the present invention, in regard to the film for laminated glass, it is preferable that the optically functional layer has a layer produced by alternately laminating high refractive index layers and low refractive index layers, both containing polymers (hereinafter, also referred to as a laminate). A film for laminated glass having such a configuration can be preferably used as an infrared reflective film. That is, it is preferable that the optically functional layer is an infrared reflective layer.

The high refractive index layer and the low refractive index layer described above are considered to be as follows. For example, there are occasions in which the component that constitute the high refractive index layer (hereinafter, high refractive index layer components) and the components that constitute the low refractive index layer (hereinafter, low refractive index layer components) are mixed at the interface of the two layers, and a layer containing the high refractive index layer components and the low refractive index layer components (mixed layer) is formed. In this case, in the mixed layer, aggregation of sites containing the high refractive index layer components at a proportion of 50% by mass or more is designated as the high refractive index layer, and aggregation of sites containing the low refractive index layer components at a proportion of more than 50% by mass is designated as the low refractive index layer.

Specifically, in a case in which the low refractive index layer contains, for example, a first metal oxide as a low refractive index layer component, and the high refractive index layer contains a second metal oxide as a high refractive index layer component, the metal oxide concentration profiles in the thickness direction in a laminated film of these layers are measured, and a layer can be regarded as a high refractive index layer or a low refractive index layer, based on the composition of the layer.

The metal oxide concentration profile of a laminated film can be observed by performing etching from the surface in the depth direction using a sputtering method, performing sputtering using an XPS surface analyzer at a rate of 0.5 nm/min by taking the outermost surface as 0 nm, and measuring the atomic composition ratio. Furthermore, in regard to a laminate in which the low-refractive index components or the high-refractive index components do not include metal oxide particles, and any one of the high refractive index layer or the low refractive index layer is formed from a water-soluble polymer (organic binder) only, when the existence of a mixed region is confirmed by measuring, for example, the carbon concentration in the thickness direction from a water-soluble polymer (organic binder) concentration profile, and measuring the composition of the mixed region by EDX, each layer that has been etched by sputtering can be regarded as a high refractive index layer or a low refractive index layer.

The reflective layer may be configured to include at least one or more laminates in which high refractive index layers and low refractive index layers, both containing polymers, are alternately laminated on a film for laminated glass; however, the upper limit of the total number of the high refractive index layers and the low refractive index layers is preferably 100 layers or fewer, that is, 50 units or fewer. Furthermore, the film for laminated glass of the present invention may be configured to include at least one or more laminates on the resin film, and for example, the laminate may be a laminated film in which any one of the outermost layer and the lowermost layer of the laminate is a high refractive index layer or a low refractive index layer. However, it is preferable that both the uppermost layer and the lowermost layer are low refractive index layers. When the uppermost layer is a low refractive index layer, it is preferable from the viewpoint that coatability is improved, and when the lowermost layer is a low refractive index layer, it is preferable from the viewpoint that adhesiveness is improved.

In regard to the film for laminated glass of the present invention, the refractive index of the high refractive index layer is preferably 1.70 to 2.50, more preferably 1.80 to 2.20, and even more preferably 1.90 to 2.20. Furthermore, the refractive index of the low refractive index layer of the present invention is preferably 1.10 to 1.60, more preferably 1.30 to 1.55, and even more preferably 1.30 to 1.50.

In regard to an infrared reflective layer, it is preferable to design the infrared reflective layer to have a large difference between the refractive indices of the high refractive index layer and the low refractive index layer, from the viewpoint that a high infrared reflectance can be obtained with a small number of layers. However, according to the present invention, in at least one unit composed of a high refractive index layer and a low refractive index layer, the difference in the refractive index between a high refractive index layer and a low-refractive index that are adjacent to each other is preferably 0.1 or more, more preferably 0.3 or more, and even more preferably 0.4 or more

Furthermore, in regard to a film for laminated glass having an infrared reflective layer (infrared reflective film) according to the present invention, it is preferable that the difference in the refractive index layer between a high refractive index layer and a low refractive index layer that are adjacent to each other is 0.1 or more. However, in a case in which the film for laminated glass has multiple layers for the high refractive index layer and the low refractive index layer, respectively, it is preferable that all the refractive index layers satisfy the above-described requirements. However, in regard to the outermost layer or the lowermost layer, the layers may also have configurations other than the requirements described above.

The reflectance for a particular wavelength range is determined by the difference between the refractive indices of adjacent two layers (a high refractive index layer and a low refractive index layer) and the number of laminated layers. As the difference between the refractive indices is larger, the same reflectance is obtained with a smaller number of layers. This difference in the refractive index and the required number of layers can be calculated using a commercially available optical design software program. For example, in order to obtain an infrared shield rate of 90% or higher, if the difference in the refractive index is smaller than 0.1, more than 100 laminated layers are needed, so that not only productivity is decreased, but also scattering at the laminated layer interfaces is increased, and transparency is decreased. From the viewpoint of increasing reflectance and decreasing the number of layers, there is no upper limit in the difference in the refractive index; however, a substantially limit for the difference in the refractive index is about 1.40.

The difference in the refractive index is obtained by determining the refractive indices of the high refractive index layer and the low refractive index layer according to the method described below, and the difference between the two values is designated as the difference in the refractive index.

Various refractive index layers are produced as single layers (if necessary, using a base material), and these samples are cut into a size of 10 cm×10 cm, and then the refractive indices are determined according to the methods described below. A spectrophotometer, Model U-4000 (manufactured by Hitachi, Ltd.) is used, and the surface on the reverse side of the measurement surface (back surface) of each sample is subjected to surface roughening, and then to a light absorption treatment with a black spray to prevent reflection of light at the back surface. Reflectance for light in the visible range (400 to 700 nm) is measured at 25 points under the conditions of 5-degree regular reflection, and the average value is determined. From the measurement results, the average refractive index is determined.

(Low Refractive Index Layer and High Refractive Index Layer)

According to the present specification, the terms “high refractive index layer” and “low refractive index layer” mean that when the difference between the refractive indices of adjacent two layers is studied by making a comparison, a refractive index layer having a higher refractive index is designated as a high refractive index layer, and a refractive index layer having a lower refractive index is designated as a low refractive index layer. Therefore, regarding the terms “high refractive index layer” and “low refractive index layer”, in a case in which attention is paid to two adjacent refractive index layers among various refractive index layers that constitute a light reflective film, the relevant terms are to include all forms other than a form in which various refractive index layers have the same refractive index.

Furthermore, regarding the optical characteristics of the film for laminated glass, it is preferable that the transmittance for the visible light region as measured according to JIS R 3106 (1998) is 60% or higher, and the film for laminated glass has a region having a reflectance of higher than 50% for light having a wavelength in the range of 800 to 1400 nm.

The thickness (thickness after drying) per layer of the refractive index layers is preferably 20 to 1,000 nm, and more preferably 50 to 500 nm.

[Polymer]

The optically functional layer according to the present invention contains a polymer. The low refractive index layer and the high refractive index layer that constitute a reflective layer based on a multilayer film, essentially contains polymers. When the material that forms a refractive index layer is a polymer, a film-forming method such as coating or spin coating can be selected. These methods are convenient, and since the heat resistance of the base material is not a matter of question, there is a wide range of alternatives. Thus, these methods may be considered as film-forming methods that are effective particularly for resin base materials. For example, if a coating mode is selected, a large-quantity production system such as a roll-to-roll method can be employed, and this is advantageous in view of cost as well as the duration of process. Furthermore, since a film containing a polymer has high flexibility, there is an advantage that even if the film is wound into a roll at the time of production or at the time of transportation, defects are not easily generated, and the film exhibits excellent handleability.

Since the polymer included in the high refractive index layer has satisfactory film-forming properties, it is preferable that the polymer includes at least one selected from the group consisting of a polyester, a polycarbonate, and a poly(meth)acrylate. The polymer that constitutes a refractive index layer may be of a single kind, or two or more kinds of polymers may be used. The percentage content of a polyester, a polycarbonate and a poly(meth)acrylate in the polymer is preferably 60% to 100% by mass, and more preferably 80% to 100% by mass, in view of the effects described above.

A polyester has a structure obtainable by polycondensing a dicarboxylic acid component and a diol component. The polyester may also be a copolymer. Examples of polymers that can be used as polyesters include polyethylene naphthalate (PEN) and isomers thereof (for example, PEN bonded at the 2,6-positions, 1,4-positions, 1,5-positions, 2,7-positions, and 2,3-positions of the naphthalene ring), polyalkylene terephthalates (for example, polyethylene terephthalate, polypropylene terephthalate, polybutylene terephthalate, and poly-1,4-cyclohexane dimethylene terephthalate), and polyethylene diphenylate. Among them, the polyester is preferably a polyalkylene terephthalate or a polyalkylene naphthalate because these polymers have a high infrared shield effect, are inexpensive, and can be used for a very wide variety of applications. The polyester is more preferably a polyalkylene terephthalate, and even more preferably polyethylene terephthalate.

Examples of the polycarbonate include aromatic polycarbonates based on bisphenols (bisphenol A and the like), and aliphatic polycarbonates such as diethylene glycol bisallyl carbonate.

A poly(meth)acrylate is a polymer of an acrylic acid ester or a methacrylic acid ester, and examples thereof include polymethyl methacrylate and polyethyl methacrylate.

The weight average molecular weights of the polyester, polycarbonate and polyacrylate that are incorporated into the high refractive index layer are about 10,000 to 1,000,000, and preferably 50,000 to 800,000. Meanwhile, regarding the weight average molecular weight, a value measured by gel permeation chromatography (GPC) is employed.

The high refractive index layer may also include an additional polymer other than the polyester, polycarbonate and poly(meth)acrylate. Examples of the additional polymer include the polymers listed as the polymer to be used for the low refractive index layer described below.

The polymer to be incorporated into the low refractive index layer is not particularly limited; however, examples thereof include polyethylene naphthalate (PEN) and isomers thereof (for example, PEN bonded at the 2,6-positions, 1,4-positions, 1,5-positions, 2,7-positions, and 2,3-positions of the naphthalene ring), polyalkylene terephthalates (for example, polyethylene terephthalate, polypropylene terephthalate, polybutylene terephthalate, and poly-1,4-cyclohexane dimethylene terephthalate), polyimides (for example, polyacrylic acid imide), polyetherimide, atactic polystyrene, polycarbonates, polymethacrylates (for example, polyisobutyl methacrylate, polypropyl methacrylate, polyethyl methacrylate, and polymethyl methacrylate), poly(meth)acrylates (for example, polybutyl acrylate and polymethyl acrylate), cellulose derivatives (for example, ethyl cellulose, cellulose acetate, cellulose propionate, cellulose butyrate, and nitrocellulose), polyalkylene polymers (for example, polyethylene, polypropylene, polybutylene, polyisobutylene, and poly(4-methyl)pentene), fluorinated polymers (for example, a perfluoroalkoxy resin, polytetrafluoroethylene, a fluorinated ethylene-propylene copolymer, polyvinylidene fluoride, and polychlorotrifluoroethylene), a chlorinated polymer (for example, polyvinylidene chloride and polyvinyl chloride), polysulfone, polyether sulfone, polyacrylonitrile, polyamide, a silicone resin, an epoxy resin, polyvinyl acetate, polyetheramide, an ionomer resin, elastomers (for example, polybutadiene, polyisoprene, and neoprene), and polyurethanes. Copolymers, for example, copolymers of PEN (for example, copolymers of 2,6-, 1,4-, 1,5-, 2,7-, and/or 2,3-naphthalenedicarboxylic acids or esters thereof, with (a) terephthalic acid or esters thereof, (b) isophthalic acid or esters thereof, (c) phthalic acid or esters thereof, (d) alkane glycols, (e) cycloalkane glycols (for example, cyclohexane dimethanol diol), (f) alkane dicarboxylic acids, and/or (g) cycloalkane dicarboxylic acids (for example, cyclohexane dicarboxylic acid)), copolymers of polyalkylene terephthalates (for example, copolymers of terephthalic acid or esters thereof, with (a) naphthalene dicarboxylic acid or esters thereof, (b) isophthalic acid or esters thereof, (c) phthalic acid or esters thereof, (d) alkane glycols, (e) cycloalkane glycols (for example, cyclohexane dimethanoldiol), (f) alkane dicarboxylic acids, and/or (g) cycloalkane dicarboxylic acids (for example, cyclohexane dicarboxylic acid)), styrene copolymers (for example, a styrene-butadiene copolymer and a styrene-acrylonitrile copolymer), a copolymer of 4,4′-dibenzoic acid and ethylene glycol, and the like can also be utilized. Furthermore, individual layers may also respectively include a blend of two or more of the polymers or copolymers (for example, a blend of sPS and atactic polystyrene).

Among the polymers described above, the polymer material that is included in the low refractive index layer is preferably poly(meth)acrylate, a polyalkylene polymer, a cellulose derivative or the like, from the viewpoint of an infrared shielding effect.

The weight average molecular weight of the polymer that is included in the low refractive index layer is about 10,000 to 1,000,000, and preferably 50,000 to 800,000. Meanwhile, regarding the weight average molecular weight, a value measured by gel permeation chromatography (GPC) is employed.

The content of the polymer in the low refractive index layer is 50% to 100% by mass, more preferably 70% to 100% by mass, with respect to the total solid content of the low refractive index.

[Water-Soluble Polymer]

According to another embodiment of the present invention, it is preferable that the polymer that is included in the high refractive index layer and the low refractive index layer includes at least one water-soluble polymer. In this case, it is preferable to use fine metal oxide particles for the adjustment of the refractive index. That is, it is preferable that the optically functional layer has a layer produced by alternately laminating high refractive index layers containing at least fine metal oxide particles and a water-soluble polymer, and low refractive index layers containing at least a water-soluble polymer. By adopting such a configuration, the infrared reflectance can be increased.

The water-soluble polymer can be used without particular limitations as long as a layer containing fine metal oxide particles can be formed. However, when environmental problems or flexibility of a layer thus formed are considered, the water-soluble polymer is preferably a polyvinyl alcohol-based resin, gelatin, a cellulose, a polysaccharide thickener, a polymer having a reactive functional group, or the like. Among these, a polyvinyl alcohol-based resin is particularly preferred from the viewpoint of the infrared reflectance.

Furthermore, it is preferable to use a curing agent in order to cure the water-soluble polymer.

(Polyvinyl Alcohol-Based Resin)

As the polyvinyl alcohol-based resin, various modified polyvinyl alcohols are also included, in addition to conventional polyvinyl alcohol obtainable by hydrolyzing polyvinyl acetate.

The polyvinyl alcohol obtainable by hydrolyzing vinyl acetate is preferably a polymer having an average degree of polymerization of 1,000 or more, and particularly preferably a polymer having an average degree of polymerization of 1,500 to 5,000 (high refractive index layer: PVA-124, degree of polymerization 2,400, degree of saponification 88 mol %, low refractive index layer:). Furthermore, the degree of saponification is preferably 70% to 100%, and particularly preferably 80% to 99.9%.

Examples of the modified polyvinyl alcohol include a cationic modified polyvinyl alcohol, an anionic modified polyvinyl alcohol, a nonionic modified polyvinyl alcohol, and a vinyl alcohol-based polymer. Furthermore, a vinyl acetate-based resin (for example, “EXCEVAL” manufactured by Kuraray Co., Ltd.), a polyvinyl acetal resin obtainable by reacting polyvinyl alcohol with aldehyde (for example, “S-LEC” manufactured by Sekisui Chemical Co., Ltd.), a silanol-modified polyvinyl alcohol having a silanol group (for example, “R-1130” manufactured by Kuraray Co., Ltd.), a modified polyvinyl alcohol-based resin having an acetoacetyl group in the molecule (for example, “GOHSEFIMER (registered trademark) Z/WR series” manufactured by Nippon Synthetic Chemical Industry Co., Ltd.), and the like are also included in polyvinyl alcohol-based resins.

Examples of the anionic modified polyvinyl alcohol include a polyvinyl alcohol having an anionic group as described in JP 1-206088 A; copolymers of vinyl alcohol and vinyl compounds having water-soluble groups as described in JP 61-237681 A and JP 63-307979 A; and a modified polyvinyl alcohol having a water-soluble group as described in JP 7-285265 A.

Furthermore, examples of the nonionic modified polyvinyl alcohol include a polyvinyl alcohol derivative having a polyalkylene oxide group added to a portion of vinyl alcohol as described in JP 7-9758 A; a block copolymer of vinyl alcohol and a vinyl compound having a hydrophobic group as described in JP 8-25795 A; a silanol-modified polyvinyl alcohol having a silanol group; and a reactive group-modified polyvinyl alcohol having a reactive group such as an acetoacetyl group, a carbonyl group or a carboxyl group.

Examples of the cationic modified polyvinyl alcohol include a polyvinyl alcohol having a primary, secondary or tertiary amino group or a quaternary ammonium group in the main chain or a side chain of the polyvinyl alcohol as described in JP 61-10483 A, which is obtainable by saponifying a copolymer of an ethylenically unsaturated monomer having a cationic group and vinyl acetate.

Examples of the ethylenically unsaturated monomer having a cationic group include trimethyl-(2-acrylamido-2, 2-dimethylethyl) ammonium chloride, trimethyl-(3-acrylamido-3, 3-dimethylpropyl) ammonium chloride, N-vinylimidazole, N-vinyl-2-methylimidazole, N-(3-dimethylaminopropyl)methacrylamide, hydroxyethyltrimethylammonium chloride, trimethyl(2-methacrylamidopropyl) ammonium chloride, and N-(1, 1-dimethyl-3-dimethylaminopropyl) acrylamide. The proportion of a cationic modified group-containing monomer in a cationic modified polyvinyl alcohol is preferably 0.1 mol % to 10 mol %, and more preferably 0.2 mol % to 5 mol %, with respect to vinyl acetate.

Examples of the vinyl alcohol-based polymer include EXCEVAL (trade name; manufactured by Kuraray Co., Ltd.) and NICHIGO G POLYMER (trade name: manufactured by Nippon Synthetic Chemical Industry Co., Ltd.).

Meanwhile, the water-soluble polymers described above may be used singly, or two or more kinds thereof may be used in combination. Furthermore, regarding the water-soluble polymer, a synthetic product may be used, or a commercially available product may be used.

The weight average molecular weight of the water-soluble polymer is preferably 1,000 to 200,000, and more preferably 3,000 to 60,000. Meanwhile, according to the present specification, regarding the value of “weight average molecular weight”, a value measured by astatic light scattering method, a gel permeation chromatography method (GPC), TOFMASS or the like may be employed. When the weight average molecular weight of the water-soluble polymer is in the range described above, application by a wet film-forming method is made possible, and productivity can be increased, which is preferable.

The content of the water-soluble polymer in the low refractive index layer is preferably 5% to 75% by mass, and more preferably 10% to 70% by mass, relative to 100% by mass of the total solid content of the low refractive index layer. When the content of the water-soluble polymer is 5% by mass or more, in a case in which a low refractive index layer is formed by a wet film-forming method, it is preferable because at the time of drying a coating film obtained by application, deterioration of transparency caused by disorderliness at the film surface can be prevented. On the other hand, when the content of the water-soluble polymer is 75% by mass or less, the content becomes a content suitable in a case in which metal oxide particles are incorporated into the low refractive index layer, and the difference in the refractive index between the low refractive index layer and the high refractive index layer can be made larger, which is preferable. Meanwhile, according to the present specification, the content of the water-soluble polymer can be determined from the residual solid content obtainable by an evaporation drying method. Specifically, a film for laminated glass is immersed in hot water at 95° C. for 2 hours, remaining film is removed, and then the hot water is evaporated. The amount of solids thus obtained is designated as the amount of the water-soluble polymer. At this time, in a case in which one peak is observed respectively in the regions of 1,700 to 1,800 cm⁻¹, 900 to 1,000 cm⁻¹, and 800 to 900 cm⁻¹ in the IR (infrared spectroscopy) spectrum, the water-soluble polymer can be identified as polyvinyl alcohol.

[Fine Metal Oxide Particles]

In regard to the fine metal oxide particles used for the refractive index layers together with a water-soluble polymer, it is preferable to use first fine metal oxide particles for the high refractive index layer, and second fine metal oxide particles for the low refractive index layer, in view of adjusting the refractive indices.

(First Fine Metal Oxide Particles)

The first metal oxide particles that are applicable to the high refractive index layer are preferably metal oxide particles having a refractive index of from 2.0 to 3.0. Furthermore, specific examples thereof include particles of titanium oxide, zirconium oxide, zinc oxide, synthetic amorphous silica, colloidal silica, alumina, colloidal alumina, lead titanate, red lead, chrome yellow, zinc yellow, chromium oxide, ferric oxide, iron black, copper oxide, magnesium oxide, magnesium hydroxide, strontium titanate, yttrium oxide, niobium oxide, europium oxide, lanthanum oxide, zircon, and tin oxide. Furthermore, composite oxide particles composed of multiple metals, or core-shell particles in which the metal composition varies with the core-shell form, can also be used.

In order to form a high refractive index layer that is transparent and has a higher refractive index, it is preferable to incorporate fine oxide particles of a metal having high a refractive index, such as titanium or zirconium, that is, at least any one of fine titanium oxide particles or fine zirconia oxide particles. Among these, from the viewpoint of the stability of the coating liquid for forming the high refractive index layer, titanium oxides are more preferable. Furthermore, among titanium oxides, particularly rutile type (tetragonal system) is more preferred to anatase type, because the rutile type has lower catalytic activity, so that weather resistance of the high refractive index layer or adjacent layers is increased, and the refractive index is further increased.

Furthermore, in a case in which core-shell particle are used as the first metal oxide particles for the high refractive index layer, from the viewpoint of an effect that interlayer mixing between the high refractive index layer and adjacent layers is suppressed as a result of an interaction between the silicon-containing hydrated oxide of the shell layer and the first water-soluble polymer, core-shell particles in which titanium oxide particles are coated with a silicon-containing hydrated oxide are even more preferred.

Regarding the aqueous solution containing titanium oxide particles that are used as the cores of the core-shell particles according to the present invention, it is preferable to use an aqueous solution which has a pH in the range of 1.0 to 3.0, and in which the surface of a water-based titanium oxide sol containing titanium particles having a positive zeta potential value, has been hydrophobized to make the particles dispersible in an organic solvent.

When the content of the first metal oxide particles is 15% to 80% by mass relative to 100% by mass of the solid content of the high refractive index layer, it is preferable from the viewpoint of imparting a difference in the refractive index between the high refractive index layer and the low refractive index layer. Furthermore, the content of the first metal oxide particles is more preferably 20% to 77% by mass, and even more preferably 30% to 75% by mass. Meanwhile, in a case in which metal oxide particles other than the relevant core-shell particles are incorporated into the high refractive index layer according to the present invention, the content of the metal oxide particles is not particularly limited as long as the content is used to the extent that the effects of the present invention can be provided.

According to the present invention, the volume average particle size of the first metal oxide particles that are applicable to the high refractive index layer is preferably 30 nm or less, more preferably 1 to 30 nm, and even more preferably 5 to 15 nm. When the volume average particle size is from 1 nm to 30 nm, it is preferable from the viewpoint of having a low haze value and excellent visible light transmissibility.

Meanwhile, the volume average particle size of the first metal oxide particles according to the present invention is a volume-weighted average particle size represented by the formula: volume average particle size mv={Σ(vi·di)}/{Σ(vi)}, in the case in which, for a population of a particulate metal oxide including n1, n2, . . . , ni, . . . and nk particles having particle sizes of d1, d2, . . . , di, . . . and dk, respectively, the volume per particle is designated as vi, when the particle sizes of any arbitrary 1000 particles are measured by a method of observing the particles themselves using a laser diffraction scattering method, a dynamic light scattering method or electron microscopy, or by a method of observing particle images appearing in a cross-section or the surface of the refractive index layer using electron microscopy.

(Second Fine Metal Oxide Particles)

Regarding the second metal oxide particles that are applicable to the low refractive index layer, it is preferable to use silica (silicon dioxide), and specific examples thereof include synthetic amorphous silica and colloidal silica. Furthermore, in order to further reduce the refractive index, hollow fine particles having a cavity inside each particle can be used as the second metal oxide particles that are applicable to the low refractive index layer.

Regarding the second metal oxide particles (preferably silicon dioxide) that are applicable to the low refractive index layer, particles having an average particle size in the range of 3 to 100 nm are preferred. The average particle size of primary particles of silicon dioxide that are disperse in the form of primary particles (particle size in the state of a dispersion liquid before coating) is more preferably 3 to 50 nm, even more preferably 3 to 40 nm, particularly preferably 3 to 20 nm, and most preferably 4 to 10 nm. Furthermore, it is preferable that the average particle size of secondary particles is 30 nm or less, from the viewpoint of having a low haze value and excellent visible light transmissibility.

The average particle size of the second fine metal oxide particles that are applicable to the low refractive index layer can be determined by observing the particles themselves or particles appearing in a cross-section or the surface of the refractive index layer using electron microscopy, measuring the particle sizes of any arbitrary 1000 particles, and calculating the simple mean value of the particle sizes (number average). Here, the particle size of an individual particle is represented by the diameter of an imaginary circle assumed to have the same area as the projected area of the relevant particle.

The colloidal silica that may be used for the present invention is obtainable by heating and aging a silica sol that is obtained by subjecting sodium silicate to metathesis using an acid or the like, or bypassing sodium silicate through an ion exchange resin layer, and examples of colloidal silica include those described in JP 57-14091 A, JP 60-219083 A, JP 60-219084 A, JP 61-20792 A, JP 61-188183 A, JP 63-17807 A, JP 4-93284 A, JP 5-278324 A, JP 6-92011 A, JP 6-183134 A, JP 6-297830 A, JP 7-81214 A, JP 7-101142 A, JP 7-179029 A, JP 7-137431 A, and WO 94/26530.

Regarding such colloidal silica, a synthesized product may be used, or a commercially available product may also be used. The colloidal silica may have its surface cationically modified, or may have its surface treated with Al, Ca, Mg, Ba or the like.

Regarding the second metal oxide particles that are applicable to the low refractive index layer, hollow particles can also be used. In the case of using hollow particles, the average particle cavity diameter is preferably 3 to 70 nm, more preferably 5 to 50 nm, and even more preferably 5 to 45 nm. Meanwhile, the average particle cavity diameter of hollow particles is the average value of the internal diameters of the hollow particles. According to the present invention, when the average particle cavity diameter of the hollow particles is in the range described above, the refractive index of the low refractive index layer is sufficiently lowered. The average particle cavity diameter is obtained by observing 50 or more randomly selected cavity diameters that can be observed as a circular shape, an elliptical shape, or a substantially circular or elliptical shape by electron microscopic observation, determining the cavity diameters of the various particles, and determining the number average value of the cavity diameters. Meanwhile, the average particle cavity diameter means the minimum distance among the distances measured between any two parallel lines tangent to the outer periphery of a cavity diameter that can be observed as a circular shape, an elliptical shape, or a substantially circular or elliptical shape.

The second metal oxide particles that are applicable to the low refractive index layer may have the surfaces coated with a surface coating component.

The content of the second metal oxide particles in the low refractive index layer is preferably 0.1% to 70% by mass, more preferably 30% to 70% by mass, and even more preferably 45% to 65% by mass, relative to 100% by mass of the solid content of the low refractive index layer.

(Curing Agent)

According to the present invention, it is preferable to use a curing agent in order to cure the water-soluble polymer. Such a curing agent is not particularly limited as long as the curing agent is capable of causing a curing reaction with the relevant water-soluble polymer. For example, in a case in which polyvinyl alcohol is used as the water-soluble polymer, boric acid and salts thereof are preferable as the curing agent. In addition to boric acid and salts thereof, known agents can be used, and generally, a compound having a group that can react with polyvinyl alcohol or a compound that accelerates a reaction between different groups carried by polyvinyl alcohol is appropriately selected and used.

Specific examples of the curing agent include, for example, epoxy-based curing agents (for example, diglycidyl ethyl ether, ethylene glycol diglycidyl ether, 1,4-butanediol diglycidyl ether, 1,6-diglycidyl cyclohexane, N,N-diglycidyl-4-glycidyloxyaniline, sorbitol polyglycidyl ether, and glycerol polyglycidyl ether), aldehyde-based curing agents (for example, formaldehyde and glyoxal), active halogen-based curing agents (for example, 2,4-dichloro-4-hydroxy-1,3,5-s-triazine), active vinyl-based compounds (for example, 1,3,5-trisacryloylhexahydro-s-triazine and bisvinylsulfonyl methyl ether), and aluminum alum.

Boric acid and salts thereof refer to an oxyacid having a boron atom as a central atom, and salts thereof. Specific examples include ortho-boric acid, diboric acid, metaboric acid, tetraboric acid, pentaboric acid, and octaboric acid, as well as salts thereof.

The content of the curing agent is preferably 1% to 10% by mass, and more preferably 2% to 6% by mass, relative to 100% by mass of the solid content of the low refractive index layer.

The total amount of use of the curing agent in the case of using polyvinyl alcohol as the water-soluble polymer is preferably 1 to 600 mg per gram of polyvinyl alcohol, and more preferably 100 to 600 mg per gram of polyvinyl alcohol.

(Other Additives for Various Refractive Index Layers)

In the high refractive index layer and the low refractive index layer according to the present invention, if necessary, various additives such as, for example, a surfactant, a dispersion aid, an ultraviolet absorber, a pH adjusting agent, a defoamant, an antistatic agent, and a matting agent, can be used. Furthermore, the content of the additives in the high refractive index layer is preferably 0% to 20% by mass relative to 100% by mass of the solid content of the high refractive index layer.

(Method for Forming Reflective Layer)

Regarding the method for forming a reflective layer, a known method can be used. In a case in which the polymer is a water-soluble polymer, it is preferable to form the reflective layer by applying a wet coating method, and a production method including a step of performing wet coating, on the resin film of the present invention, a coating liquid for a high refractive index layer containing a water-soluble polymer and first metal oxide particles, and a coating liquid for a low refractive index layer containing a water-soluble polymer and second metal oxide particles, is more preferred.

<Optically Functional Layer Absorbing Particular Light by Means of Dye or Pigment>

An optically functional layer that absorbs a particular wavelength by means of a dye or a pigment will be explained by taking an infrared absorbing layer as an example.

Examples of the material that is incorporated into the infrared absorbing layer include an ultraviolet-cured resin as a polymer, a photopolymerization initiator, and an infrared absorber. It is preferable for the infrared absorbing layer that the polymer component included therein has been cured. Here, the term curing means that the polymer component undergoes a reaction under the effect of active energy radiation such as ultraviolet radiation, heat or the like, and is cured.

The ultraviolet-cured resin has superior hardness and smoothness compared to other resins, and it is also advantageous from the viewpoint of dispersibility of ITO (tin-doped indium oxide), ATO (antimony-doped tin oxide) or thermally conductive metal oxides. The ultraviolet-cured resin can be used without any particular limitations as long as the resin can forma transparent layer as a result of curing, and examples thereof include a silicone resin, an epoxy resin, a vinyl ester resin, an acrylic resin, and an allyl ester resin. More preferred is an acrylic resin from the viewpoints of hardness, smoothness and transparency.

It is preferable from the viewpoints of hardness, smoothness and transparency that the acrylic resin includes reactive silica particles having a photosensitive group having photopolymerization reactivity introduced into the surface (hereinafter, also simply referred to as “reactive silica particles”), which are described in WO 2008/035669. Here, examples of the photosensitive group having photopolymerizability include polymerizable unsaturated groups represented by a (meth)acryloyloxy group. Furthermore, the ultraviolet-cured resin may also include a compound capable of undergoing a photopolymerization reaction with a photosensitive group having photopolymerization reactivity that has been introduced into the surface of these reactive silica particles, for example, an organic compound having a polymerizable unsaturated group.

Furthermore, silica particles on which a polymerizable unsaturated group-modified hydrolyzable silane produces a silyloxy group between the silane and a silica particle as a result of a hydrolysis reaction of the hydrolyzable silyl group and is chemically bonded, can also be used as the reactive silica particles. Here, the average particle size of the reactive silica particles is preferably 0.001 to 0.1 μm. When the average particle size is adjusted to such a range, the requirements for transparency, smoothness and hardness can be satisfied in a well-balanced manner.

Furthermore, from the viewpoint of adjusting the refractive index, it is preferable that the acrylic resin contains fluorine. That is, it is preferable that the infrared absorbing layer contains fluorine. Examples of such an acrylic resin include an acrylic resin containing a constituent unit derived from a fluorine-containing vinyl monomer. Examples of the fluorine-containing vinyl monomer include fluoro-olefins (for example, fluoroethylene, vinylidene fluoride, tetrafluoroethylene, and hexafluoropropylene), partially or fully fluorinated alkyl ester derivatives of (meth)acrylic acid (for example, VISCOAT 6FM (trade name, manufactured by Osaka Organic Chemical Industry, Ltd.) and R-2020 (trade name, manufactured by Daikin Industries, Ltd.)), and fully or partially fluorinated vinyl ethers.

Regarding the photopolymerization initiator, known agents can be used, and the photopolymerization initiators can be used singly or in combination of two or more kinds thereof.

Regarding an inorganic infrared absorber that can be incorporated into the infrared absorbing layer, from the viewpoints of visible light transmittance, infrared absorbability, suitability for dispersion in a resin, and the like, ITO, ATO, zinc antimonate, lanthanum hexaboride (LaB₆), cesium-containing tungsten oxide (Cs_{0.33}WO₃), and the like are preferred.

These can be used singly or in combination of two or more kinds thereof. The average particle size of the inorganic infrared absorber is preferably 5 to 100 nm, and more preferably 10 to 50 nm. If the average particle size is less than 5 nm, dispersibility in a resin or infrared absorbability may be deteriorated. On the other hand, if the average particle size is larger than 100 nm, the visible light transmittance may be deteriorated.

Meanwhile, in regard to the measurement of the average particle size, images are captured by transmission electron microscopy, 50 particles for example are randomly extracted, the particle sizes of these particles are measured, and the average of the particle sizes is determined. Furthermore, in a case in which the shape of the particles is not a spherical shape, the particle size is defined as a value calculated by measuring the major axis.

The content of the inorganic infrared absorber in the infrared absorbing layer is preferably 1% to 80% by mass, and more preferably 5% to 50% by mass, with respect to the total mass of the infrared absorbing layer. When the content is 1% or more, a sufficient infrared absorbing effect is exhibited. When the content is 80% or less, the infrared absorbing layer can transmit a sufficient amount of visible light.

Furthermore, examples of an organic infrared absorbing material include polymethine-based, phthalocyanine-based, naphthalocyanine-based, metal complex-based, aminium-based, immonium-based, diimmonium-based, anthraquinone-based, dithiol metal complex-based, naphthoquinone-based, indolephenol-based, azo-based, and triallylmethane-based compounds. Metal complex-based compounds, aminium-based compounds (aminium derivatives), phthalocyanine-based compounds (phthalocyanine derivatives), naphthalocyanine-based compounds (naphthalocyanine derivatives), diimmonium-based compounds (diimmonium derivatives), squalium-based compounds (squalium derivatives), and the like are particularly preferably used.

In regard to the infrared absorbing layer, metal oxides other than those described above, or other infrared absorbers such as organic infrared absorbers or metal complexes may also be incorporated to the extent that the effects of the present invention are provided. Specific examples of such other infrared absorbers include, for example, diimmonium-based compounds, aluminum-based compounds, phthalocyanine-based compounds, organic metal complexes, cyanine-based compounds, azo compounds, polymethine-based compounds, quinone-based compounds, diphenylmethane-based compounds, and triphenylmethane-based compounds.

The thickness of the infrared absorbing layer is preferably in the range of 0.1 to 50 μm, and more preferably in the range of 1 to 20 μm. When the thickness is 0.1 μm or more, the infrared absorption ability tends to increase, and when the thickness is 50 μm or less, cracking resistance of the coating film is enhanced.

The method for forming the infrared absorbing layer is not particularly limited, and for example, a method of forming the infrared absorbing layer by preparing a coating liquid for an infrared absorbing layer containing the various components described above, subsequently applying the coating liquid using a wire bar or the like, and drying the coating liquid, may be employed.

<<Other Constituent Layers of Film for Laminated Glass>>

The film for laminated glass according to the present invention may have, on a resin film, functional layers such as a heat insulating layer, an antistatic layer, a gas barrier layer, an easily adhesive layer (adhesive layer), an antifouling layer, a deodorizing layer, a dripping layer, an easily lubricating layer, a hard coat layer, an abrasion resistant layer, and an antireflective layer, for the purpose of adding new functions.

<<Adhesive Layer>>

It is preferable for the laminated glass of the present invention that an adhesive layer is provided on either surface of the film for laminated glass, and thereby a glass substrate is bonded.

It is preferable that the film for laminated glass of the present invention has an adhesive layer on at least one surface side. The adhesive layer is preferably constituted of a pressure-sensitive adhesive, and examples of the pressure-sensitive adhesive include, without any particular limitations, an acrylic pressure-sensitive adhesive, a silicone-based pressure-sensitive adhesive, a urethane-based pressure-sensitive adhesive, a polyvinyl butyral-based pressure-sensitive adhesive, and an ethylene-vinyl acetate-based pressure-sensitive adhesive.

For this adhesive layer, additives such as, for example, a stabilizer, a surfactant, an ultraviolet absorber, a flame retardant, an antistatic agent, an oxidation inhibitor, a thermal stabilizer, a lubricating agent, a filler, a colorant, and an adhesion adjusting agent can be incorporated into the layer. Particularly, in a case in which the film for laminated glass is used for window sticking as in the present invention, addition of an ultraviolet absorber is effective, also in order to suppress deterioration of the infrared shielding film caused by ultraviolet radiation.

The thickness of the adhesive layer is preferably 1 to 100 μm, and more preferably 3 to 50 μm. When the thickness is 1 μm or more, pressure-sensitive adhesiveness tends to increase, and a sufficient pressure-sensitive adhesive force is obtained. On the contrary, when the thickness is 100 μm or less, transparency of the film for laminated glass is enhanced, and also, when the film for laminated glass is adhered to a glass substrate and then peeled off, the occurrence of cohesive failure within the adhesive layer can be prevented.

The method for forming the adhesive layer on the film for laminated glass is not particularly limited, and an adhesive layer-attached film for laminated glass can be produced by, for example, producing a pressure-sensitive adhesive coating liquid containing the pressure-sensitive adhesive, subsequently applying the coating liquid on a film for laminated glass using a wire bar or the like, and drying the coating liquid.

<<Glass Substrate>>

Next, the glass substrate that is applicable to the laminated glass of the present invention will be explained.

Regarding the glass substrate according to the present invention, commercially available glass can be used. There are no particular limitations on the kind of glass, and usually, soda lime silica glass is suitably used. In this case, the glass may be colorless transparent glass, or may also be colored transparent glass.

Furthermore, between the two sheets of glass substrates, the glass substrate on the outdoor side, which is close to incident light, is preferably a colorless transparent glass. The glass substrate on the indoor side, which is far from the incident light side, is preferably a greenish colored transparent glass, a deep-colored transparent glass, or a colorless transparent glass. It is preferable that the greenish colored transparent glass has ultraviolet absorbing performance and infrared absorbing performance. It is because when these are used, the solar radiation energy coming through the outdoor side can be reflected, and the solar radiation transmittance of the laminated glass can be reduced.

There are no particular limitations on the greenish colored transparent glass; however, a suitable example thereof is a soda lime silica glass containing iron. For example, the greenish colored transparent glass is a soda lime silica glass obtained by incorporating iron into a soda lime silica-based mother glass at a total iron content of 0.3% to 1% by mass in terms of Fe₂O₃. Furthermore, since the absorption of light having a wavelength in the near-infrared region is dominantly achieved by divalent iron among all the iron species, it is preferable that the mass of FeO (divalent iron) is 20% to 40% by mass of the total iron content in terms of Fe₂O₃.

In order to impart ultraviolet absorbing performance, a method of adding cerium or the like to a soda lime silica-based mother glass may be employed. Specifically, it is substantially preferable to use a soda lime silica glass having the following composition: SiO₂: 65% to 75% by mass, Al₂O₃: 0.1% to 5% by mass, Na₂O+K₂O: 10% to 18% by mass, CaO: 5% to 15% by mass, MgO: 1% to 6% by mass, total iron content in terms of Fe₂O₃: 0.3% to 1% by mass, and total cerium content in terms of CeO₂ and/or TiO₂: 0.5% to 2% by mass.

The deep-colored transparent glass is not particularly limited; however, for example, a soda lime silica glass containing iron at a high concentration may be suitably mentioned.

On the occasion of using the laminated glass of the present invention for windows of a vehicle or the like, the thicknesses of the indoor-side glass substrate and the outdoor-side glass substrate are both preferably 1.5 to 3.0 mm. In this case, the indoor-side glass substrate and the outdoor-side glass substrate may have the same thickness, or may have different thicknesses. On the occasion of using the laminated glass for vehicle windows, for example, the thicknesses of the indoor-side glass substrate and the outdoor-side glass substrate may be both adjusted to 2.0 mm, or may be adjusted to 2.1 mm.

Furthermore, on the occasion of using the laminated glass for vehicle windows, for example, when the thickness of the indoor-side glass substrate is adjusted to be less than 2 mm, and the thickness of the outdoor-side glass substrate is adjusted to be more than 2 mm, the total thickness of the laminated glass can be reduced, and the laminated glass can resist external forces applied from the outside of the car.

The glass substrate may have a flat shape, or may have a curved surface. According to the present invention, it is preferable that the laminated glass is a laminated glass having a curved surface. In a case in which the laminated glass has a curved surface, wrinkles or undulation is likely to occur at the edge parts of the film for laminated glass; however, since the present invention has a superior effect of suppressing wrinkles or undulation, the laminated glass can be preferably applied to a laminated glass having a curved surface.

According to the present invention, a curved surface means a surface having a radius of curvature that is not infinite. The term “laminated glass having a curved surface” means that the laminated glass has a curved surface in at least a portion.

Since many of the windows for vehicles, and especially car windows, have curved surfaces, the shape of the indoor-side glass substrate and the outdoor-side glass substrate is a curved shape in many cases.

A curved glass plate is obtained by heating a soda lime glass obtained by a floating method to a temperature higher than or equal to the softening point and then bending the soda lime glass, and the curved glass can be used as a three-dimensionally curved glass plate.

The shape of a three-dimensionally curved glass plate is a spherical surface, an ellipsoidal surface, or a glass plate in which the radius of curvature varies at different sites, such as a windshield of a car. The radius of curvature of the glass substrate having a curved surface is not particularly limited; however, the radius of curvature is desirably 0.9 to 3 m. If the radius of curvature is smaller than 0.9 m, generally wrinkles in the film for laminated glass are likely to occur during lamination processing; however, even if the radius of curvature is less than 0.9 m, generation of wrinkles or undulation can be suppressed.

In this case, it is preferable that the film for laminated glass is provided on the concave surface side of the outdoor-side glass substrate.

Furthermore, three or more sheets of glass substrates can also be used as necessary.

<<Method for Producing Laminated Glass>>

The film for laminated glass can be produced into a laminated glass by being interposed between two sheets of glass substrates. The production method for use in a laminated glass preferably includes a step of producing a laminate sandwiched between glass substrates by interposing a film for laminated glass between two sheets of glass substrates, and a step of bonding the laminate sandwiched between glass substrates by heating. Regarding a detailed production method, a known method for laminated glass production can be appropriately used.

Generally, a method of inserting a film for laminated glass between two sheets of glass substrates, subsequently repeating a heating treatment and a pressurizing treatment (drawing through rubber rollers, or the like) several times, and lastly joining the film and the glass substrates by performing a heating treatment under pressurizing conditions by utilizing an autoclave or the like, is employed.

It is preferable that the laminate sandwiched between glass substrates that are not in contact with the film for laminated glass, is pressed while being heated. Joining of the glass substrates with the laminate sandwiched between the glass substrates can be achieved by, for example, preliminarily pressing the assembly at a temperature of 80° C. to 120° C. for a duration of 30 to 60 minutes under reduced pressure such as in a vacuum bag, and joining the assembly in an autoclave at a temperature of 100° C. to 150° C. at a pressure of 1.0 to 1.5 MPa. Thus, a laminated glass in which a laminate is inserted between two sheets of glass substrates can be produced. Furthermore, the members may also be bonded using a pressure-sensitive adhesive material or the like. At this time, the duration of heated pressing at a temperature of 120° C. to 150° C. at a pressure of 1.0 to 1.5 MPa is preferably 20 to 90 minutes.

After completion of heated pressing, there are no particular limitations on the cooling method, and a laminated glass may be obtained by leaving the resultant to spontaneously cool while appropriately releasing the pressure. According to the present invention, it is preferable to lower the temperature while pressure is maintained, after completion of heated pressing, from the viewpoint of further ameliorating wrinkles or cracks in the laminated glass thus obtainable. Here, when it is said that temperature is lowered while pressure is maintained, it is implied that starting with the pressure inside the apparatus at the time of heated pressing (preferably 130° C.), temperature is lowered such that the pressure inside the apparatus at 40° C. is maintained to be 75% to 100% of the pressure at the time of heated pressing.

Regarding the method for lowering temperature while maintaining pressure, there are no particular limitations as long as the pressure obtainable when temperature has been lowered to 40° C. is in the range described above. However, preferred is an embodiment in which temperature is lowered without leaking pressure from the interior of the apparatus so that the pressure inside the pressure apparatus decreases spontaneously with the decrease in temperature; or an embodiment in which temperature is lowered while pressure is further applied from the outside so that the pressure inside the apparatus does not decrease with the decrease in temperature. In a case in which temperature is lowered while pressure is maintained, it is preferable to perform heated pressing at 120° C. to 150° C., and then leave the laminated glass to cool to 40° C. for 1 to 5 hours.

After the lowering of temperature is performed while pressure is maintained, it is preferable that a step of releasing pressure is subsequently included. Specifically, it is preferable that after temperature is lowered while pressure is maintained, pressure is released after the temperature inside the autoclave reaches 40° C. or lower, and then temperature is further lowered.

As discussed above, it is preferable that the method for producing a laminated glass includes a step of laminating the constituent layers of a laminated glass; a step of subsequently joining the constituent layers by heating and pressing the layers at a temperature of 120° C. to 150° C. at a pressure of 1.0 to 1.5 MPa; a step of lowering the temperature while pressure is maintained; and a step of releasing the pressure.

### EXAMPLES

Hereinafter, the present invention will be specifically explained by way of Examples; however, the present invention is not intended to be limited to these. Meanwhile, description of “parts” or “percent (%)” is used in the Examples; however, unless particularly stated otherwise, the unit represents “parts by mass” or “percent (%) by mass”.

### Example 1

<<Production of Film for Laminated Glass 1>>

<Production of Low Refractive Index Layer>

First, a coating liquid for a low refractive index layer was produced. Specifically, 400 parts of colloidal silica (10% by mass) (SNOWTEX OXS; manufactured by Nissan Chemical Industries, Ltd.), 50 parts of an aqueous solution of boric acid (30% by mass), 300 parts of polyvinyl alcohol (4% by mass) (JP-45; degree of polymerization: 4,500, degree of saponification: 88 mol %, manufactured by Japan Vam & Poval Co., Ltd.), and 3 parts of a surfactant (5% by mass) (SOFTAZOLINE LSB-R; manufactured by Kawaken Fine Chemical Co., Ltd.) were added in this order at 45° C. Then, the mixture was made up to 1,000 parts with pure water, and thus a coating liquid for a low refractive index layer was produced.

<Production of High Refractive Index Layer>

(Production of Silica-Attached Titanium Dioxide Sol)

To 0.5 parts by mass of a 15.0 mass % titanium oxide sol (SRD-W, volume average particle size: 5 nm, rutile type titanium dioxide particles, manufactured by Sakai Chemical Industry Co., Ltd.), 2 parts by mass of pure water was added, and then the mixture was heated to 90° C. Subsequently, 0.5 parts by mass of an aqueous solution of silicic acid (product obtained by diluting sodium silicate No. 4 (manufactured by Nippon Chemical Industrial Co., Ltd.) with pure water so as to obtain a SiO₂ concentration of 0.5% by mass) was slowly added thereto, and then the resulting mixture was subjected to a heating treatment in an autoclave for 18 hours at 175° C. The mixture was cooled and then concentrated using an ultrafiltration member, and thereby, a titanium dioxide sol having 6% by mass of SiO₂ attached to the surface (hereinafter, silica-attached titanium dioxide sol) (volume average particle size: 9 nm) was obtained.

To 113 parts by mass of the silica-attached titanium dioxide sol (20% by mass) obtained as described above, 48 parts by mass of an aqueous solution of citric acid (1.92% by mass) was added, and 113 parts by mass of an ethylene-modified polyvinyl alcohol (manufactured by Kuraray Co., Ltd., EXCEVAL RS-2117, degree of saponification: 97.5 mol % to 99 mol %, 8% by mass) was further added thereto. The mixture was stirred, and finally 0.4 parts by mass of a 5 mass % aqueous solution of a surfactant (SOFTAZOLINE LSB-R, manufactured by Kawaken Fine Chemical Co., Ltd.) was added thereto. Thus, a coating liquid for a high refractive index layer was produced.

<Formation of Optically Functional Layer on Resin Film>

The coating liquid for a low refractive index layer and the coating liquid for a high refractive index layer obtained as described above were applied on a resin film (high thermal shrinkage type polyethylene terephthalate film having a thickness of 50 μm; described as PET-A in Table 1) that had been warmed to 45° C., while the coating liquids were maintained warm at 45° C., using a slide hopper coating apparatus by eleven-layer simultaneous multilayer application (optically functional layer: thickness 1.50 μm). At this time, low refractive index layers were employed as the lowermost layer and the uppermost layer, and the other layers were set such that low refractive index layers and high refractive index layers were respectively alternately laminated. The coating amounts were regulated such that the layer thickness at the time of drying would be 150 nm for each of the low refractive index layers, and 120 nm for each of the high refractive index layers.

In this manner, a film for laminated glass 1 was produced.

<<Production of Film for Laminated Glass 2>>

A film for laminated glass 2 was produced in the same manner as in the production of the film for laminated glass 1, except that the optically functional layer used for the production of the film for laminated glass 1 was changed to a layer including 15 layers (optically functional layer: thickness 2.04 μm).

<<Production of Film for Laminated Glass 3>>

A film for laminated glass 3 was produced in the same manner as in the production of the film for laminated glass 1, except that the optically functional layer used for the production of the film for laminated glass 1 was changed to a layer including 21 layers (optically functional layer: thickness 2.85 μm).

<<Production of Film for Laminated Glass 4>>

<Formation of Reflective Layer 1>

According to the melt extrusion method described in U.S. Pat. No. 6,049,419 B, polyethylene naphthalate (PEN) TN8065S (manufactured by Teijin Kasei, Ltd.) and polymethyl methacrylate (PMMA) resin ACRYPET VH (manufactured by Mitsubishi Rayon Co., Ltd.) were melted to 300° C. and laminated by extrusion. The laminate was stretched about 3 times longitudinally and transversely so as to obtain a ratio of (PMMA (152 nm)/PEN (137 nm)) 64/(PMMA (164 nm)/PEN (148 nm)) 64, and then thermal fixation and cooling were performed to obtain a reflective layer 1 in which 128 layers in total were alternately laminated was obtained. Here, in regard to the layer configuration described above, “(PMMA (152 nm)/PEN (137 nm)) 64” means that 64 units in which PMMA having a layer thickness of 152 nm and PEN having a layer thickness of 137 nm were laminated in this order were laminated.

The lowermost layer and the uppermost layer were formed in a form in which PET was extruded for each of the layers to a thickness of 38 μm, and the above-described configuration was sandwiched therebetween. In this manner, a film for laminated glass 4 having a PET layer on either side of the optically functional layer was produced. In a case in which a resin layer having the same thickness is provided on either surface of an optically functional layer as such, only a PET layer on one side is considered as the resin film according to the present invention. Meanwhile, for the PET, a PET film having an altered thickness was used (described as PET-B in Table 1).

<<Production of Film for Laminated Glass 5>>

A film for laminated glass 5 was produced in the same manner as in the production of the film for laminated glass 4, except that the thickness of the PET layer of the lowermost layer and the uppermost layer used for the production of the film for laminated glass 4 was changed to 12 μm.

<<Production of Film for Laminated Glass 6>>

A film for laminated glass 6 was produced in the same manner as in the production of the film for laminated glass 4, except that the thickness of the PET layer of the lowermost layer and the uppermost layer used for the production of the film for laminated glass 4 was changed to 6 μm.

<<Production of Film for Laminated Glass 7>>

A film for laminated glass 7 was produced in the same manner as in the production of the film for laminated glass 4, except that the thickness of the PET layer of the lowermost layer and the uppermost layer used for the production of the film for laminated glass 4 was changed to 5 μm.

<<Production of Film for Laminated Glass 8>>

A film for laminated glass 8 was produced in the same manner as in the production of the film for laminated glass 3, except that the resin film used for the production of the film for laminated glass 3 was changed to PET-1 described below.

<<Production of Film for Laminated Glass 9>>

A film for laminated glass 9 was produced in the same manner as in the production of the film for laminated glass 3, except that the resin film used for the production of the film for laminated glass 3 was changed to PET-2 described below.

<<Production of Film for Laminated Glass 10>>

A film for laminated glass 10 was produced in the same manner as in the production of the film for laminated glass 5, except that the PET layer of the uppermost layer and the lowermost layer used for the production of the film for laminated glass 5 was changed to PET-2 described below.

<<Production of Film for Laminated Glass 11>>

A film for laminated glass 11 was produced in the same manner as in the production of the film for laminated glass 3, except that the resin film used for the production of the film for laminated glass 3 was changed to PET-3 described below.

<<Production of Film for Laminated Glass 12>>

A film for laminated glass 12 was produced in the same manner as in the production of the film for laminated glass 3, except that the resin film used for the production of the film for laminated glass 3 was changed to PET-4 described below.

<<Production of Film for Laminated Glass 13>>

A film for laminated glass 13 was produced in the same manner as in the production of the film for laminated glass 3, except that in connection with the production of the film for laminated glass 3, the resin film PET-2 was used, and the colloidal silica of the low refractive layer was excluded.

<<Production of Film for Laminated Glass 14>>

A film for laminated glass 14 was produced in the same manner as in the production of the film for laminated glass 13, except that the resin film used for the production of the film for laminated glass 13 was changed to COSMOSHINE A4300 (polyethylene terephthalate film having a thickness 50 μm; manufactured by Toyobo Co., Ltd.).

<<Production of Film for Laminated Glass 15>>

PET-A as a transparent resin film was washed and dried, and the film was mounted in a sputtering film-forming apparatus. On the surface of the transparent resin film, 10 layers of a TiO₂ film having a film thickness of 110 nm as a high refractive index layer, and 10 layers of a SiO₂ film having a film thickness of 140 nm as a low refractive index layer were alternately laminated to form an infrared reflective layer, and thereby a film for laminated glass 15 was produced.

PET-1 to PET-4 were produced so as to have the following heat shrinkage rates. Adjustment of the heat shrinkage rate was carried out by changing the respective stretch ratios in the MD direction and the TD direction.

PET-1 (heat shrinkage rate MD direction: 2.80%, TD direction: 2.70%)

PET-2 (heat shrinkage rate MD direction: 3.30%, TD direction: 3.20%)

PET-3 (heat shrinkage rate MD direction: 4.60%, TD direction: 4.50%)

PET-4 (heat shrinkage rate MD direction: 5.40%, TD direction: 5.30%)

<<Production of Laminated Glass>>

<<Production of Laminated Glass 1>>

(Joining of Film for Laminated Glass and Glass Substrates)

A green glass having a thickness of 3 mm (visible light transmittance: 81%, sunlight transmittance: 63%) that served as an indoor-side glass; a layer formed from polyvinyl butyral having a thickness of 380 μm, which served as an indoor-side adhesive layer; the film for laminated glass 1; a layer formed from polyvinyl butyral having a thickness of 380 μm, which served as an outdoor-side adhesive layer; and a clear glass having a thickness of 3 mm (visible light transmittance: 91%, sunlight transmittance: 86%) that served as an outdoor-side glass were laminated in this order. At the edges of the glass, excess portions that had protruded were removed, and then the assembly was subjected to a joining treatment by heating the assembly at 140° C. for 30 minutes and degassing under pressure. Thus, a laminated glass 1 was produced. Furthermore, the film for laminated glass was disposed such that the resin film would come on the indoor side. Measurement of the visible light transmittance and the sunlight transmittance was performed according to JIS R 3106 (1998) using U-4000 (manufactured by Hitachi, Ltd.).

<<Production of Laminated Glasses 2 to 15>>

Laminated glasses 2 to 15 were produced in the same manner as in the production of the laminated glass 1, using the films for laminated glass 2 to 15 instead of the film for laminated glass 1.

<<Evaluation>>

<Measurement of Heat Shrinkage Rate>

The heat shrinkage rate of the resin film (polyethylene terephthalate film) used for the films for laminated glass 1 to 15 was measured as follows. The resin film is stored for 24 hours in an environment at a temperature of 23° C. and a relative humidity of 55%, and then two marks are made at an interval of 100 mm in the width direction. The distance L₁ between the two marks is measured in an unloaded state using a microscope or the like. Subsequently, the sample is suspended in an oven in an environment at 130° C., and is left to stand for 30 minutes. After a lapse of 30 minutes, the sample is taken out from the oven, and the sample is stored again for 24 hours in an environment at a temperature of 23° C. and a relative humidity of 55%. Subsequently, the distance L₂ between the two marks on the sample is measured in an unloaded state using a microscope or the like. From the distances L₁ and L₂ thus measured, the heat shrinkage rate of the resin film is calculated by the following expression:

Heat shrinkage rate (%)=((L₁−L₂)/L₁)×100

The heat shrinkage rates of the films for laminated glass 1 to 15 were also calculated in the same manner.

The measurement was made respectively in the conveyance direction (MD direction) and the width direction (TD) direction of the resin film and the film for laminated glass.

<In-Plane Uniformity>

For the laminated glasses 1 to 15, the visible light transmittance and the infrared transmittance were measured at 12 points in the plane, the difference between the maximum value and the minimum value was calculated for each transmittance, and the value of a larger difference was employed.

◯: 2.0% or less

Δ: more than 2.0% and 4.0% or less

X: more than 4.0%

(Infrared Transmittance)

The infrared transmittance (800 to 1,400 nm) in the region of 300 nm to 2,000 nm of each laminated glass was measured using a spectrophotometer (using an integral sphere, manufactured by Hitachi, Ltd., U-4000 type).

(Visible Light Transmittance)

Measurement of the visible light transmittance was performed according to JIS R 3106 (1998) using U-4000 (manufactured by Hitachi, Ltd.).

<Suitability for Curved Surface Glass>

The films for laminated glass 1 to 15 thus produced were pasted with water on a curved surface glass (radius of curvature 2 m), and the external appearance was evaluated by visual inspection according to the following evaluation criteria. Grade Δ or higher represents a level that can be supplied for practical use.

◯: Unevenness, wrinkles at the edges and the like are not observed.

Δ: Unevenness, wrinkles at the edges and the like are slightly observed in some places.

X: Unevenness, wrinkles at the edges and the like are present at several sites, and are clearly recognized.

<Infrared Reflectance>

The infrared reflectance in the thickness direction in the region of 800 to 1,400 nm of each infrared shield film was measured, and the average of values at 12 points was calculated. Measurement of the infrared reflectance was performed using a spectrophotometer U-4000 (manufactured by Hitachi, Ltd.).

The results obtained above are presented in Table 1.

TABLE 1

| | | | | | | | | Film for | | | | | | | | |
|---|---|---|---|---|---|---|---|---|---|---|---|---|---|---|---|---|
| | | | | | | | | laminated | | | | | | | | |
| | | Resin film | | | | | | glass | | | | | Evaluation results | | | |
| | | | | Heat | | Optically | | Heat | | | | | | | Infrared | |
| Film | | | | shrinkage | | functional | | shrinkage | | | | | | | reflect- | |
| for | | | | rate [%] | | layer | | rate [%] | | Ratio | Ratio of | | | Suit- | ance | |
| lami- | Lami- | | Thick- | (130° C., | | | Thick- | (130° C., | | of | heat | | In- | ability | [%] | |
| nated | nated | | ness | 30 minutes) | | Poly- | ness | 30 minutes) | | thick- | shrinkage | | plane | for | (average | |
| glass | glass | | n₂ | S₂ | | mer | n₁ | S₁ | | ness | rate S₁/S₂ | | uni- | curved | of 12 | |
| No. | No. | Material | [μM] | MD | TD | type | [μM] | MD | TD | n₁/n₂ | MD | TD | formity | glass | points) | Remarks |
| 1 | 1 | PET-A | 50 | 1.80 | 2.10 | *1 | 1.50 | 1.60 | 2.00 | 0.030 | 0.89 | 0.95 | Δ | Δ | 62 | Invented Example |
| 2 | 2 | PET-A | 50 | 1.80 | 2.10 | *1 | 2.04 | 1.59 | 1.98 | 0.041 | 0.88 | 0.94 | ∘ | Δ | 63 | Invented Example |
| 3 | 3 | PET-A | 50 | 1.80 | 2.10 | *1 | 2.85 | 1.58 | 1.95 | 0.057 | 0.88 | 0.93 | ∘ | Δ | 64 | Invented Example |
| 4 | 4 | PET-B | 38 | 1.85 | 2.15 | *2 | 38.46 | 1.70 | 2.05 | 1.012 | 0.92 | 0.95 | ∘ | Δ | 57 | Invented Example |
| 5 | 5 | PET-B | 12 | 1.90 | 2.20 | *2 | 38.46 | 1.71 | 2.07 | 3.205 | 0.90 | 0.94 | ∘ | Δ | 58 | Invented Example |
| 6 | 6 | PET-B | 6 | 2.00 | 2.25 | *2 | 38.46 | 1.72 | 2.08 | 6.410 | 0.86 | 0.92 | ∘ | Δ | 59 | Invented Example |
| 7 | 7 | PET-B | 5 | 2.00 | 2.25 | *2 | 38.46 | 1.73 | 2.09 | 7.692 | 0.87 | 0.93 | Δ | Δ | 60 | Invented Example |
| 8 | 8 | PET-1 | 50 | 2.80 | 2.70 | *1 | 2.85 | 2.50 | 2.60 | 0.057 | 0.89 | 0.96 | ∘ | Δ | 63 | Invented Example |
| 9 | 9 | PET-2 | 50 | 3.30 | 3.20 | *1 | 2.85 | 3.00 | 3.10 | 0.057 | 0.91 | 0.97 | ∘ | ∘ | 65 | Invented Example |
| 10 | 10 | PET-2 | 12 | 3.30 | 3.20 | *2 | 38.46 | 3.20 | 3.10 | 3.205 | 0.97 | 0.97 | ∘ | ∘ | 60 | Invented Example |
| 11 | 11 | PET-3 | 50 | 4.60 | 4.50 | *1 | 2.85 | 4.20 | 3.30 | 0.057 | 0.91 | 0.73 | ∘ | ∘ | 64 | Invented Example |
| 12 | 12 | PET-4 | 50 | 5.40 | 5.30 | *1 | 2.85 | 4.40 | 3.50 | 0.057 | 0.81 | 0.66 | ∘ | ∘ | 63 | Invented Example |
| 13 | 13 | PET-2 | 50 | 3.30 | 3.20 | *1 | 2.85 | 1.70 | 2.00 | 0.057 | 0.52 | 0.63 | x | x | 55 | Comparative |
| | | | | | | | | | | | | | | | | Example |
| 14 | 14 | PET | 50 | 0.90 | 0.60 | *1 | 2.85 | 1.00 | 0.55 | 0.057 | 1.11 | 0.92 | x | x | 54 | Comparative |
| | | (A4300) | | | | | | | | | | | | | | Example |
| 15 | 15 | PET-A | 50 | 1.80 | 2.10 | None | 2.50 | 0.90 | 1.00 | 0.050 | 0.50 | 0.48 | x | x | 50 | Comparative |
| | | | | | | | | | | | | | | | | Example |

*1 Low refractive index layer: Polyvinyl alcohol High refractive index layer: Ethylene-modified polyvinyl alcohol
*2 Low refractive index layer: PMMA High refractive index layer: PEN

From Table 1, it is understood that the films for laminated glass 1 to 12 of the present invention exhibits satisfactory in-plane uniformity when processed into a laminated glass, and excellent processing suitability for a glass having a curved surface, compared to the films for laminated glass 13 to 15 of Comparative Examples. Furthermore, it is understood that when the films for laminated glass are applied to infrared reflective films, the films have high infrared reflectance values and are useful as infrared reflective films.

### INDUSTRIAL APPLICABILITY

The film for laminated glass of the present invention can provide a film for laminated glass exhibiting satisfactory in-plane uniformity when processed into a laminated glass, and excellent processing suitability for a glass having a curved surface. Furthermore, a laminated glass provided with the film for laminated glass can be provided.

### REFERENCE SIGNS LIST

1 Laminated glass
2 Film for laminated glass
3 Resin film
4 Infrared reflective layer
5 High refractive index layer
6 Low refractive index layer
7A Adhesive layer
7B Adhesive layer
8A Glass substrate
8B Glass substrate

1. A film for laminated glass, the film comprising a resin film; and an optically functional layer containing a polymer on at least one surface of the resin film, wherein the heat shrinkage rate (S₁) of the film for laminated glass and the heat shrinkage rate (S₂) of the resin film obtainable after the films are left to stand for 30 minutes in an environment at 130° C. are respectively adjusted so as to satisfy the following expression (I) in a direction in the plane as well as a direction orthogonal thereto:
0.60≦S₁/S₂≦0.98 Expression (I):

2. The film for laminated glass according to claim 1, wherein a laminated glass provided with the film for laminated glass is a laminated glass having a curved surface.

3. The film for laminated glass according to claim 1, wherein the thickness of the optically functional layer and the thickness of the resin film satisfy the following expression (II):
0.035≦thickness of optically functional layer/thickness of resin film≦7.0 Expression (II):

4. The film for laminated glass according to claim 1, wherein the heat shrinkage rate (S₂) of the resin film obtainable after the resin film is left to stand for 30 minutes in an environment at 130° C. is more than 3.0% in a direction in the plane as well as a direction orthogonal thereto.

5. The film for laminated glass according to claim 1, wherein the optically functional layer has a layer formed by alternately laminating a high refractive index layer containing at least fine metal oxide particles and a water-soluble polymer, and a low refractive index layer containing at least a water-soluble polymer.

6. The film for laminated glass according to claim 1, wherein the optically functional layer is an infrared reflective layer.

7. A laminated glass comprising the film for laminated glass according to claim 1.

8. The film for laminated glass according to claim 2, wherein the thickness of the optically functional layer and the thickness of the resin film satisfy the following expression (II):
0.035≦thickness of optically functional layer/thickness of resin film≦7.0. Expression (II):

9. The film for laminated glass according to claim 2, wherein the heat shrinkage rate (S₂) of the resin film obtainable after the resin film is left to stand for 30 minutes in an environment at 130° C. is more than 3.0% in a direction in the plane as well as a direction orthogonal thereto.

10. The film for laminated glass according to claim 2, wherein the optically functional layer has a layer formed by alternately laminating a high refractive index layer containing at least fine metal oxide particles and a water-soluble polymer, and a low refractive index layer containing at least a water-soluble polymer.

11. The film for laminated glass according to claim 2, wherein the optically functional layer is an infrared reflective layer.

12. A laminated glass comprising the film for laminated glass according to claim 2.

13. The film for laminated glass according to claim 3, wherein the heat shrinkage rate (S₂) of the resin film obtainable after the resin film is left to stand for 30 minutes in an environment at 130° C. is more than 3.0% in a direction in the plane as well as a direction orthogonal thereto.

14. The film for laminated glass according to claim 3, wherein the optically functional layer has a layer formed by alternately laminating a high refractive index layer containing at least fine metal oxide particles and a water-soluble polymer, and a low refractive index layer containing at least a water-soluble polymer.

15. The film for laminated glass according to claim 3, wherein the optically functional layer is an infrared reflective layer.

16. A laminated glass comprising the film for laminated glass according to claim 3.

17. The film for laminated glass according to claim 4, wherein the optically functional layer has a layer formed by alternately laminating a high refractive index layer containing at least fine metal oxide particles and a water-soluble polymer, and a low refractive index layer containing at least a water-soluble polymer.

18. The film for laminated glass according to claim 4, wherein the optically functional layer is an infrared reflective layer.

19. A laminated glass comprising the film for laminated glass according to claim 4.

20. The film for laminated glass according to claim 5, wherein the optically functional layer is an infrared reflective layer.
